(19) United States
(12) Patent Application Publication
(10) Pub. No.: US 2015/0132188 A1
(43) Pub. Date: May 14, 2015

(54) COMBINED PARTICULATE FILTER AND HYDROCARBON TRAP

(71) Applicant: JOHNSON MATTHEY PUBLIC LIMITED COMPANY, London (GB)

(72) Inventor: Michael Anthony Howard, Royston (GB)

(21) Appl. No.: 14/237,482

(22) PCT Filed: Jun. 18, 2013
(86) PCT No.: PCT/GB2013/051580

§ 371 Date: Feb. 6, 2014

Related U.S. Application Data
(60) Provisional application No. 61/660,889, filed on Jun. 18, 2012.

(30) Foreign Application Priority Data
Jun. 20, 2012 (GB) 1210892.4

(51) Int. Cl. B01D 53/94; B01D 53/04

(52) U.S. Cl. CPC B01D 53/9486; B01D 53/0407; B01D 53/9454; B01D 53/944; B01D 2253/108; B01D 2253/116
USPC 422/115; 96/153; 422/169; 422/171

(57) ABSTRACT

A combined particulate filter and hydrocarbon trap for use in collecting particulate matter and trapping hydrocarbons present in exhaust gas is disclosed. The particulate filter comprises a porous substrate having both inlet and outlet surfaces which are separated from each other by the porous substrate wherein either or both of the inlet and outlet surfaces are coated with a washcoat comprising a hydrocarbon adsorbent material. The hydrocarbon adsorbent material is one or a combination of molecular sieves and the hydrocarbon adsorbent comprises both Ag and Pd, both Ag and Pt or all three of Ag, Pt and Pd.

The present invention relates to a combined particulate filter and hydrocarbon trap for use in collecting particulate matter from and trapping hydrocarbons present in exhaust gas. In particular the invention relates to a combined particulate filter and hydrocarbon trap for use in collecting particulate matter from and trapping hydrocarbons present in exhaust gas of a vehicular internal combustion engine, particularly a gasoline direct injection engine and especially a gasoline direct injection engine at cold start.

Ambient particulate is typically divided into the following categories based on their aerodynamic diameter (the aerodynamic diameter is defined as the diameter of a 1 g/cm³ density sphere of the same settling velocity in air as the measured particle):

(i) Particles of an aerodynamic diameter of less than 10 μm (PM-10);

(ii) Fine particles of diameter below 2.5 μm (PM-2.5);

(iii) Ultrafine particles of diameter below 100 nm; and

(iv) Nanoparticles of diameter below 50 nm.

Since the mid-1990s, particle size distributions of particulates exhausted from internal combustion engines have received increasing attention due to possible adverse health effects of fine and ultrafine particles. Concentrations of PM-10 particulates in ambient air are regulated by law in the USA. A new, additional ambient air quality standard for PM-2.5 was introduced in the USA in 1997 as a result of health studies that indicated a strong correlation between human mortality and the concentration of fine particles below 2.5 μm.

Interest has now moved to consider ultrafine and nanoparticles generated by diesel and gasoline engines because they are understood to penetrate more deeply into human lungs than particulates of greater size and consequently they are believed to be more harmful than larger particles. This belief is extrapolated from the findings of studies into particulates in the 2.5-10.0 μm range.

Size distributions of diesel particulates have a well-established bimodal character that correspond to the particle nucleation and agglomeration mechanisms, with the corresponding particle types referred to as the nuclei mode and the accumulation mode respectively. In the nuclei mode, diesel particulate is composed of numerous small particles holding very little mass. Nearly all nuclei mode diesel particulates have sizes of significantly less than 1 μm, i.e. they comprise a mixture of fine, ultrafine and nanoparticles.

Nuclei mode particles are believed to be composed mostly of volatile condensates (hydrocarbons, sulfuric acid, nitric acid etc.) and contain little solid material, such as ash and carbon. Accumulation mode particles are understood to comprise solids (carbon, metallic ash etc.) intermixed with condensates and adsorbed material (heavy hydrocarbons, sulfur species, nitrogen oxide derivatives etc.). Coarse mode particles are not believed to be generated in the diesel combustion process and may be formed through mechanisms such as deposition and subsequent re-entrainment of particulate material from the walls of an engine cylinder, exhaust system, or the particulate sampling system.

The composition of nucleating particles may change with engine operating conditions, environmental condition (particularly temperature and humidity), dilution and sampling system conditions. Laboratory work and theory have shown that most of the nuclei mode formation and growth occur in the low dilution ratio range. In this range, gas to particle conversion of volatile particle precursors, like heavy hydrocarbons and sulfuric acid, leads to simultaneous nucleation and growth of the nuclei mode and adsorption onto existing particles in the accumulation mode. Laboratory tests (see e.g. SAE 980525 and SAE 2001-01-0201) have shown that nuclei mode formation increases strongly with decreasing air dilution temperature but there is conflicting evidence on whether humidity has an influence.

Generally, low temperature, low dilution ratios, high humidity and long residence times favour nanoparticles formation and growth. Studies have shown that nanoparticles consist mainly of volatile material like heavy hydrocarbons and sulfuric acid with evidence of solid fraction only at very high loads.

Particulate collection of diesel particulates in a diesel particulate filter is based on the principle of separating gas-borne particulates from the gas phase using a porous barrier. Diesel filters can be defined as deep-bed filters and/or surface-type filters. In deep-bed filters, the mean pore size of filter media is bigger than the mean diameter of collected particles. The particles are deposited on the media through a combination of depth filtration mechanisms, including diffusional deposition (Brownian motion), inertial deposition (impaction) and flow-line interception (Brownian motion or inertia).

In surface-type filters, the pore diameter of the filter media is less than the diameter of the particulate matter, so particulate matter is separated by sieving. Separation is done by a build-up of collected diesel particulate matter itself, which build-up is commonly referred to as “filtration cake” and the process as “cake filtration”.

It is understood that diesel particulate filters, such as ceramic wallflow monoliths, may work through a combination of depth and surface filtration: a filtration cake develops at higher soot loads when the depth filtration capacity is saturated and a particulate layer starts covering the filtration surface. Depth filtration is characterized by somewhat lower filtration efficiency and lower pressure drop than the cake filtration.

Contrastingly, engine-out size distributions of gasoline particulates in steady state operation show a unimodal distribution with a peak of about 60-80 nm (see for example FIG. 4 in SAE 1999-01-3530). By comparison with diesel size distribution, gasoline particulate matter is predominantly ultrafine, i.e. nuclei mode, with negligible accumulation and coarse mode.

Emission legislation in Europe from 1 Sep. 2014 (Euro 6) requires control of the number of particles emitted from both diesel and gasoline (positive ignition) passenger cars. For gasoline EU light duty vehicles the allowable limits are: 1000 mg/km carbon monoxide; 60 mg/km nitrogen oxides (NOₓ); 100 mg/km total hydrocarbons (of which <68 mg/km are non-methane hydrocarbons); and 4.5 mg/km particulate matter ((PM) for direct injection engines only). The Euro 6 PM standard will be phased in over a number of years with the standard from the beginning of 2014 being set at 6.0×10¹² per km (Euro 6) and the standard set from the beginning of 2017 being 6.0×10¹¹ per km (Euro 6+).

It is understood that the US Federal LEV III standards have been set at 3 mg/mile mass limit (currently 10 mg/mile) over US FTP cycle from 2017-2021. The limit is then yet further tightened to 1mg/mile from 2025, although implementation of this lower standard may be brought forward to 2022.

The new Euro 6 (Euro 6 and Euro 6+) emission standard presents a number of challenging design problems for meeting gasoline emission standards. In particular, how to design a filter, or an exhaust system including a filter, for reducing the number of PM gasoline (positive ignition) emissions, yet at the same time meeting the emission standards for non-PM pollutants such as one or more of oxides of nitrogen (NOx), carbon monoxide (CO) and unburned hydrocarbons (HC), all at an acceptable back pressure, e.g. as measured by maximum on-cycle backpressure on the EU drive cycle.

It is envisaged that a minimum of particle reduction for a three-way catalysed particulate filter to meet the Euro 6 PM number standard relative to an equivalent flowthrough catalyst is >50%. Additionally some backpressure increase for a three-way catalysed wallflow filter relative to an equivalent flowthrough catalyst will be inevitable.

PM generated by positive ignition engines has a significantly higher proportion of ultrafine, with negligible accumulation and coarse mode compared with that produced by diesel (compression ignition) engines, and this presents challenges to removing it from positive ignition engine exhaust gas in order to prevent its emission to atmosphere. Studies on particulate emissions from direct injection spark ignition gasoline engines (SAE 2007-01-0209) have revealed that they are significantly higher than port fuel injected engines due to the reduced time available for mixture preparation and increased incidence of fuel impingement on to pistons and combustion surface chambers.

In particular, since a majority of PM derived from a positive ignition engine is relatively small compared with the size distribution for diesel PM, it is not practically possible to use a filter substrate that promotes positive ignition PM surface-type cake filtration because the relatively low mean pore size of the filter substrate that would be required would produce unpractical high backpressure in the system. Furthermore, generally it is not possible to use a conventional wallflow filter, designed for trapping diesel PM, for promoting surface-type filtration of PM from a positive ignition engine in order to meet relevant emission standards because there is generally less PM in positive ignition exhaust gas, so formation of a soot cake is less likely; and positive ignition exhaust gas temperatures are generally higher, which can lead to faster removal of PM by oxidation, thus preventing increased PM removal by cake filtration. Depth filtration of positive ignition PM in a conventional diesel wallflow filter is also difficult because the PM is significantly smaller than the pore size of the filter medium. Hence, in normal operation, an uncoated conventional diesel wallflow filter will have a lower filtration efficiency when used with a positive ignition engine than a compression ignition engine.

Backpressure also increases with washcoat loading and soot loading. Therefore another difficulty is combining filtration efficiency with a washcoat loading, e.g. of catalyst for meeting emission standards for non-PM pollutants, at acceptable backpressures. Diesel wallflow particulate filters in commercially available vehicles today have a mean pore size of about 13 μm. However, it was disclosed in WO2010/097634 that washcoating a filter of this type at a sufficient catalyst loading such as is described in US 2006/0133969 to achieve required gasoline (positive ignition) emission standards can cause unacceptable backpressure.

In order to reduce filter backpressure it is possible to reduce the length of the substrate. However, there is a finite level below which the backpressure increases as the filter length is reduced.

There has been a number of disclosures of filters to meet the Euro 6 emission standards for gasoline fuelled internal combustion engines, typically where the filter is coated with a washcoat comprising a three way catalyst.

US 2009/0193796 discloses a three way catalyst (TWC) coated onto a particulate trap suitable for use with gasoline direct injection engines. The Examples disclose a soot filter having a catalytic material prepared using two coats: an inlet coat and an outlet coat. The mean pore size of the soot filter substrate used is not mentioned. The inlet coat contains alumina, an oxygen storage component (OSC) and rhodium all at a total loading of 0.17 g in⁻³; the outlet coat includes alumina, an OSC and palladium, all at a total loading of 0.42 g in⁻³. However, such a three way catalyst washcoat loading of <0.5 g in⁻³ may provide insufficient three way activity to meet the required emission standards alone, i.e. the claimed filter appears to be designed for inclusion in a system for location downstream of a three-way catalyst comprising a flowthrough substrate monolith.

WO 2009/043390 discloses a catalytically active particulate filter comprising a filter element and a catalytically active coating composed of two layers. The first layer is in contact with the in-flowing exhaust gas while the second layer is in contact with the out-flowing exhaust gas. Both layers contain aluminium oxide. The first layer contains palladium, the second layer contains an oxygen-storing mixed cerium/zirconium oxide in addition to rhodium. In the Examples, a wallflow filter substrate of unspecified mean pore size is coated with a first layer at a loading of approximately 31 g/l and a second layer at a loading of approximately 30 g/l. That is, the washcoat loading is less than 1.00 g in⁻³. For a majority of vehicle applications, this coated filter may not be able to meet the required emission standards alone.

WO 2010/097634 discloses adaption of a relatively porous particulate filter—such as a particulate filter adapted for a diesel application—so that it can be used to trap ultrafine positive ignition PM at an acceptable pressure drop and backpressure. This is achieved by addition of a washcoat that hinders access of the PM to a porous structure of a filter substrate. This has been found to beneficially promote surface filtration substantially at the expense of depth filtration to the extent that cake filtration of PM derived from a positive ignition engine is promoted or enhanced.

None of these disclosures focuses on collection of PM when the engine is started from cold. It has recently been disclosed in SAE 2011-01-1212 that, for a EURO 4 calibrated vehicle with gasoline direct injection during the European Driving Cycle, a major amount of particulate mass and number is emitted in the early phase when the engine is cold and the catalyst system is still not fully operational (see FIG. 2 in this paper).

As discussed above the type of filter required for gaseous particulate filters is different from that for diesel particulate filters. It follows that methodologies for regeneration of such filters may also differ to the known regeneration methodologies employed for diesel filters. A variety of strategies are available for active diesel engine regeneration which include engine management to increase exhaust temperature through late fuel injection or injection during the exhaust stroke, use of a fuel borne catalyst to reduce the soot burn out temperature (reductions can be from >600° C. to 350-450° C.), addition of a fuel burner after the turbo to increase the exhaust temperature, a catalytic oxidiser to increase the exhaust temperature, with after injection, resistive heating coils to increase the exhaust temperature, microwave energy to increase the particulate temperature and various combinations of the above strategies.

For regeneration of gasoline filters the size and type of particulate matter differs from that in diesel filter and also the exhaust gas temperature is higher than that for diesel engines. Some strategies for active regeneration of gaseous particulate filters have been proposed. For example, in US 2011/0072788 a method for regenerating a gasoline particulate filter is disclosed which comprises oscillating an exhaust air-fuel ratio entering the particulate filter to generate air-fuel ratio oscillations downstream of the particulate filter, while increasing exhaust temperature; when the downstream oscillations are sufficiently dissipated, enleaning the exhaust air-fuel ratio entering the particulate filter; and reducing the enleanment when an exhaust operating parameter is beyond a threshold amount.

It is mentioned in US 2009/0193796 that optionally the gasoline particulate filter can be catalysed with a soot burning catalyst for regeneration of the particulate filter. There is no further detail as to the catalyst type. There is also a viewpoint that active regeneration may not be required as the temperature of the exhaust gas from combustion of the gasoline internal combustion engine may be sufficiently high for passive regeneration.

It is postulated in WO 2010/097634 that the soot in the gaseous particulate filter combusts at lower temperatures than soot in a diesel particulate filter.

None of these disclosures attempts to address regeneration of a gaseous filter where PM has been collected immediately after the engine is started from cold.

For gasoline engines, aftertreatment of the exhaust gases by the traditional TWC combined with engine management of air fuel ratios achieves useful reductions of carbon monoxide, hydrocarbon and nitrogen oxides pollutants. The TWC is most efficient when it is exposed to exhaust from an engine running slightly above the stoichiometric point. This point is between 14.6 and 14.8 parts air to 1 part fuel, by weight, for gasoline fuelled internal combustion engines. Furthermore to be effective the TWC generally requires the temperature of the exhaust gas to be not lower than 300° C.

As in the case of PM most hydrocarbon emissions are produced (about 60 to 80% of the total emitted) in the cold start period of the vehicle. During cold start the TWC is not effective as the exhaust gas has not yet reached about 300° C. Various strategies have been utilised to reduce the cold start period and/or capture cold start hydrocarbons. These include locating a three way catalyst as close to the engine manifold as possible (a so-called “close-coupled” catalyst), electrically heated catalysed metal monoliths, hydrocarbon traps, chemically heated catalysts, exhaust gas ignition, preheat burners, cold-start spark retard or post-manifold combustion, variable valve combustion chambers, double walled exhaust pipe and combinations thereof. Optimisation of strategies to reduce the cold start period has led to cold start periods in the engine of as low as 30s.

A variety of hydrocarbon traps has been developed to adsorb and retain hydrocarbons emitted at cold start and then release them to the TWC once the TWC is at an effective temperature. Initial materials proposed for hydrocarbon capture were gamma alumina, porous glass, activated charcoal and the like as these materials were expected to be stable when exposed to typical exhaust gas temperatures for gasoline engines of 800° C. and higher. However these materials were found to be not sufficiently absorptive of the hydrocarbons and they lost much of their absorptivity at the higher temperatures.

Zeolites are known to have very good hydrocarbon absorption properties. Various methods have been developed for hydrocarbon trap and release using selected zeolites and catalysed selected zeolites. For example SAE 2001-01-0660 discloses development of a hydrocarbon absorbent based on zeolite that is capable of trapping hydrocarbons at cold start and then releasing them into the exhaust gas phase on to a TWC at higher temperatures. Combinations of ZSM 5 and Y-type zeolites were found suitable for C₃ and higher hydrocarbons and silver ion exchanged ferrierite (FER) for C₂ hydrocarbons. These absorbents were found to be stable at high exhaust gas temperatures over a prolonged period. Many zeolites and catalysed zeolites are not stable at the high exhaust gas temperatures in a gasoline engine.

To address this hydrocarbon traps have been positioned downstream of a TWC so that the exhaust gas has cooled before contacting the trap. However such an arrangement necessarily requires an additional system component such as an oxidation trap placed further downstream of the hydrocarbon trap to convert desorbed hydrocarbons. U.S. Pat. No. 6,074,973 discloses a hydrocarbon trap comprising silver dispersed on zeolites, typically ZSM-5 wherein the hydrocarbon trap is positioned downstream of a TWC. More recently hydrocarbon traps have been proposed in a bypass system such that the trap is exposed to exhaust gases at start up and then only up to a temperature slightly above the light off temperature of the three way catalyst to desorb the gases before the exhaust gas is diverted through the TWC whilst bypassing the hydrocarbon trap. EP 0424966 A discloses such a system. In such a system the highest temperature the hydrocarbon trap is exposed to is slightly above the light off temperature of the TWC. Therefore the life of the trap is potentially increased and zeolites do not have to be stable at high temperatures such as traps in in-line systems. Investigations by the present inventor led to the selection of mordenite, Y-type and ZSM-5 zeolites as most preferable absorbents for the hydrocarbon trap. Addition of one or two of Pt, Pd, Rh, Fe and Cu to the absorbent was found to aid its regeneration at lower temperatures.

To meet the future legislative requirements it is an object of the present invention to provide a combined particulate filter and hydrocarbon trap that can effectively trap hydrocarbons and also effectively collect particulate matter present in exhaust gas. It is an object of the present invention to provide such a filter/trap combination that is effective during cold start in vehicles, specifically in gasoline vehicles and especially in direct injection gasoline vehicles.

Such a filter/trap combination must be designed such that as well as effectively trapping the hydrocarbon and collecting particulate matter it can be effectively regenerated to prevent a build-up of backpressure due to soot blocking the filter and it must be capable of desorbing the hydrocarbon effectively so that the hydrocarbon can be converted using TWC and/or alternatively used as a catalyst for regeneration of the collected particulate matter. The washcoat loading must be carefully chosen to prevent a build-up of back pressure as well. Furthermore the hydrocarbon adsorbent needs to be active at low temperatures whilst being resistant to higher temperatures within the exhaust gas that it may be exposed to.

We have now identified a filter/trap combination that we believe can meet the above requirements. More specifically we have identified a filter/trap combination that we believe can meet the above requirements for an engine at cold start.

According to a first aspect, the invention provides a combined particulate filter and hydrocarbon trap for use in collecting particulate matter and trapping hydrocarbons present in exhaust gas wherein the particulate filter comprises a porous substrate having both inlet and outlet surfaces which are separated from each other by the porous substrate wherein either or both of the inlet and outlet surfaces are coated with a washcoat comprising a hydrocarbon adsorbent material, wherein the hydrocarbon adsorbent material is one or a combination of molecular sieves and wherein the hydrocarbon adsorbent comprises both Ag and Pd, both Ag and Pt or all three of Ag, Pt and Pd.

The porous substrate can be a metal, such as a sintered metal, or a ceramic, e.g. silicon carbide, cordierite, aluminium nitride, silicon nitride, aluminium titanate, alumina, cordierite, mullite e.g., acicular mullite (see e.g. WO 01/16050), pollucite, a thermet such as Al₂O₃/Fe, Al₂O₃/Ni or B₄C/Fe, or composites comprising segments of any two or more thereof. Types of filter include a wall flow filter or a foam or a so called partial filter, such as those disclosed in EP 1057519 or WO 01/080978. In a preferred embodiment, the filter is a wallflow filter comprising a ceramic porous substrate. Wall flow filters of the current invention preferably have cell densities of up to 400 cpsi.

The porous substrate has surface pores of a mean pore size. Mean pore size can be determined by mercury porosimetry. The mean pore size is from 8 to 45 μm, for example 8 to 25 μm, 10 to 20 μm or 13 to 20 μm. It will be understood that the benefit of the invention is substantially independent of the porosity of the substrate. Porosity is a measure of the percentage of void space in a porous substrate and is related to backpressure in an exhaust system: generally, the lower the porosity, the higher the backpressure. However, the porosity of filters for use in the present invention are typically >40% or >50% and porosities of 45-75% such as 50-65% or 55-65% can be used.

Either or both of the inlet and outlet surfaces of the porous substrate can be coated with a washcoat. Additionally either one or both of the inlet and outlet surfaces can include a plurality of washcoat layers, wherein each washcoat layer within the plurality of layers can be the same or different. The washcoat intended for coating on outlet surfaces is not necessarily the same as for inlet surfaces. Typical mean pore sizes for the washcoat are less than 8 μm. The mean pore size of the washcoat on inlet surfaces can be different to that on outlet surfaces.

In one embodiment the washcoat is a surface washcoat. This is defined as a washcoat layer substantially covering surface pores of the porous structure and substantially no washcoat enters the porous structure of the porous substrate. Methods of making surface coated porous filter substrates include introducing a polymer into the porous structure, applying a washcoat to the substrate and polymer followed by drying and calcining the coated substrate to burn the polymer out or appropriate formulation of the washcoat by a skilled person including adjusting viscosity, particle size and surface wetting characteristics and application of an appropriate vacuum following coating of the porous substrate (see WO 99/47260 and WO 2011/080525).

In an alternative embodiment the washcoat is coated on inlet and outlet surfaces and also within the porous structure of the porous substrate. Methods of making such a filter involve appropriate formulation of the washcoat by a skilled person including adjusting viscosity, particle size and surface wetting characteristics and application of an appropriate vacuum following coating of the porous substrate. WO99/47260 and WO 2011/080525 disclose such a method.

In a third embodiment the washcoat sits substantially within the porous structure i.e. it permeates the porous structure of the porous substrate.

It is preferable for the mean pore size of a washcoat applied to an inlet surface to be smaller than the mean pore size of the porous substrate to prevent or reduce any combustion ash or debris entering the porous structure.

In all embodiments the surface porosity of the washcoat can be increased by including voids therein. By void is meant a space existing in the layer defined by solid washcoat material. Voids can include any vacancy, fine pore, tunnel-state, slit and can be introduced by including in a washcoat composition for coating on the porous substrate a material that is combusted during calcination of a coated porous filter substrate, for example chopped cotton or materials to give rise to pores made by formation of gas on decomposition or combustion. The average void of the washcoat can be from 5 to 80% with the average void diameter from 0.2 to 500 μm.

In embodiments of the invention the washcoat loading on the particulate filter is >0.25 g/in³, preferably greater than 0.50 g/in³ and more preferably greater than 0.8 g/in³, for example 0.80 to 3.00 g/in³.

The washcoat comprises a hydrocarbon adsorbent. Hydrocarbons in exhaust gases are comprised of paraffin, olefin and aromatics. Each of these components contains hydrocarbons of various sizes ranging from C₁ to C₁₁. Effective hydrocarbon adsorbents must adsorb all these hydrocarbon sizes. Generally hydrocarbon adsorbents are molecular sieves. A hydrocarbon adsorbent material typically preferred is one or a combination of zeolites or an isotype such as a SAPO. Zeolites are microporous, aluminosilicate minerals. As of November 2010, 194 unique zeolite frameworks have been identified, and over 40 naturally occurring zeolite frameworks are known. For use in the present invention especially preferred zeolites and/or isotypes such as SAPO are those that can demonstrate a sufficiently high adsorbancy for hydrocarbons emitted from engine exhaust gas up to a relatively high temperature with no discernible performance reduction for a long period of use at such high temperature with high durability. The definition of high temperature and the high durability will be dependent on where the filter/trap is placed relative to the exhaust gas emissions and what temperature of exhaust gas emissions are allowed to pass through the filter/trap. For example in a by-pass system the adsorbent will typically be exposed to temperatures not more than 50° C. above the temperature at which the TWC is effective. Therefore the choice of hydrocarbon adsorbent will be one that has most effective adsorption properties at low temperatures and can be effectively regenerated at temperatures typically not more than 50° C. above the temperature at which the TWC is effective. However, when the trap/filter combination is placed in-line the adsorbent will typically be exposed to temperatures of up to 800° C. For trapping hydrocarbons at cold start as a minimum the hydrocarbon adsorbent must at least be able to adsorb hydrocarbons emitted from engine exhaust gas at temperatures up to that at which the TWC is active. To meet the above requirements preferred zeolites of the invention include mordenite, Y type zeolite, ferrierite, beta and ZSM-5. The pore size of the zeolite is not important but pore sizes at least 0.1 nm greater than the molecular diameter of the hydrocarbon emitted from the exhaust gas are preferred for maximum adsorption of the hydrocarbons. Preferred silica to alumina ratios are from 30 to 280, with values at the lower end of the range when the hydrocarbon adsorbent is present in a bypass arrangement.

The hydrocarbon adsorbent may further comprise one or more of a group IIIB element, for example one or more of cerium, lanthanum, neodymium and yttrium. These metals are known to improve hydrothermal stability of zeolites.

It is postulated that C₂ hydrocarbons can be chemically adsorbed by these precious metals by molecular sieves comprising both Ag and Pd, both Ag and Pt or all three of Ag, Pt and Pd. In particular embodiments, the hydrocarbon adsorbent can comprise the precious metals ruthenium, iridium or both ruthenium and iridium. The precious metals can be impregnated into the hydrocarbon adsorbent. Alternatively, if one or more of the zeolites used is aluminium containing, for example ferrierite, the precious metal can be incorporated into the ferrierite by an ion exchange mechanism. The improvement in trapping efficiency means that low washcoat loadings can be used which lowers the backpressure of the filter/trap, meaning that regeneration to burn off the particulates collected can be done on a less frequent basis. Furthermore the metals are also thought to aid regeneration of the adsorbent at lower temps and also lower the temperature at which particulate matter can be burnt off. This is especially useful, for example, when the filter/trap is in a by-pass system.

The hydrocarbon adsorbent may further comprise an oxygen storage component (OSC). The OSC is chosen such that it loses oxygen storage capability between ambient temperature and an operating temperature at which the absorber material has degraded and does not trap hydrocarbons. For in-line hydrocarbon absorbents the operating temperature for a gasoline engine may be up to 800° C. For a by-pass arrangement the operating temperature for the hydrocarbon absorbent will typically be less than 300° C. Therefore different OSC are required dependant on the positioning of the filter/trap in the exhaust system. The skilled person will be able to select a suitable OSC by routine experimentation having regard to the temperature of gas exhaust the filter/trap will be exposed to. However, presently preferred OSC materials include ceria, ceria-zirconia and ceria-zirconia stabilised with one or more lanthanide elements (see WO 2011/027228).

In a preferred embodiment the hydrocarbon adsorbent further comprises at least one precious metal as disclosed above and at least one or more of a group IIIB element.

In an especially preferred embodiment the hydrocarbon adsorbent further comprises at least one precious metal as disclosed above and at least one or more of a group IIIB element.

According to a second aspect, the invention provides an exhaust system comprising a combined particulate filter and hydrocarbon trap for use in collecting particulate matter and trapping hydrocarbons present in exhaust gas of a vehicular engine, particularly a gasoline direct injection engine wherein the particulate filter comprises a porous substrate having both inlet and outlet surfaces which are separated from each other by the porous substrate wherein either or both of the inlet and outlet surfaces are coated with a washcoat comprising a hydrocarbon adsorbent material.

The exhaust system may comprise a TWC. Examples of TWC are as disclosed in the literature and the active components in a typical TWC comprise one or both of Pt and Pd in combination with Rh, or even Pd only, supported on a high surface area oxide, and an oxygen storage component, for example cerium dioxide or a mixed oxide containing cerium e.g. ceria-zirconia.

The TWC may be disposed upstream and/or downstream of the combined particulate filter and hydrocarbon trap. In one embodiment the filter/trap is disposed upstream of the TWC. A preferred embodiment is that the filter/trap is positioned downstream of a first TWC and a further system component such as an oxidation catalyst or a second TWC is disposed downstream of the filter/trap to combust hydrocarbons released from the hydrocarbon adsorbing component when the temperature of the filter/trap increases to above the temperature at which hydrocarbons are desorbed. In this embodiment the filter/trap may be exposed to exhaust temperatures lower than those of when it is positioned upstream of the TWC, for example if it is upstream and in-line with the TWC. Actual exposure temperatures will depend on how far downstream of the TWC the combined filter/trap is positioned in the exhaust system.

The TWC and combined filter/trap may be each disposed in a separate container in the exhaust system or they may be disposed together in a single container in the exhaust system.

The combined filter/trap may be disposed separately from and directly in-line with the TWC.

Alternatively in an extremely preferred embodiment of the invention the combined filter/trap is positioned separately from the TWC in a by-pass system. Such a by-pass system is as defined in for example EP 0424966 A1 and WO11/027228. In this embodiment, the passage of exhaust gas through the exhaust system is controlled by at least one change over valve.

The passage of exhaust gas in the exhaust system may be controlled by at least one valve and control means for controlling the at least one valve, which control means being programmed, when in use, such that:

a) at engine cold start the exhaust gas flows only through the combined particulate filter and hydrocarbon trap;

b) the exhaust gas by-passes the combined particulate filter and hydrocarbon trap once the exhaust gas reaches a temperature just below the hydrocarbon desorption temperature of the hydrocarbon trap;

c) the exhaust gas flows through the combined particulate filter and hydrocarbon trap for a second time once the three way catalyst reaches its activation temperature;

d) the exhaust gas by-passes the combined particulate filter and hydrocarbon trap for a second time once the temperature of the exhaust gas is high enough to desorb any trapped hydrocarbons and burn off any particulate matter.

At this point the combined filter/trap is then fully regenerated and is not exposed to any higher temperatures. Therefore the filter/trap has an extended lifetime as compared to those exposed to higher temperature exhaust gases.

According to a third aspect, the invention provides a vehicular internal combustion engine comprising an exhaust system according to the second aspect of the invention. The vehicular engine may be powered by either diesel fuel or gasoline fuel. Gasoline fuel is preferred in the present invention. Especially preferred is a direct injection gasoline engine. The direct injection engine may also be fuelled by gasoline fuel blended with oxygenates including methanol and/or ethanol, liquid petroleum gas or compressed natural gas.

According to a fourth aspect, the invention provides a vehicle comprising an internal combustion engine according to the third aspect of the invention.

According to a fifth aspect, the invention provides the use of a combined particulate filter and hydrocarbon trap according to the first aspect of the invention or of an exhaust system according to the second aspect of the invention to treat particulate matter and hydrocarbons in vehicular engine exhaust gas.

In a particularly preferred embodiment, the use of the fifth aspect is for treating vehicular engine cold start exhaust gas.

In a further use embodiment wherein the hydrocarbon adsorbent is a molecular sieve, a pore size of the molecular is selected to be at least 0.1 nm greater than a molecular diameter of hydrocarbons typically emitted in the exhaust gas.

For the avoidance of any doubt, the entire contents of any and all prior art documents cited herein are incorporated herein by reference.

1. A combined particulate filter and hydrocarbon trap for use in collecting particulate matter and trapping hydrocarbons present in exhaust gas wherein the particulate filter comprises a porous substrate having both inlet and outlet surfaces which are separated from each other by the porous substrate wherein either or both of the inlet and outlet surfaces are coated with a washcoat comprising a hydrocarbon adsorbent material, wherein the hydrocarbon adsorbent material is one or a combination of molecular sieves and wherein the hydrocarbon adsorbent comprises both Ag and Pd, both Ag and Pt or all three of Ag, Pt and Pd.

2. A combined particulate filter and hydrocarbon trap according to claim 1, wherein the particulate filter is a wall flow filter comprising a ceramic porous substrate.

3. A combined particulate filter and hydrocarbon trap according to claim 1, wherein the or each molecular sieve is selected from the group consisting of zeolites and isotypes thereof.

4. A combined particulate filter and hydrocarbon trap according to claim 3, wherein the or each zeolite is selected from the group consisting of mordenite, Y-type, ferrierite, beta and ZSM-5.

5. A combined particulate filter and hydrocarbon trap according to claim 1, wherein the hydrocarbon adsorbent comprises one or more of a group IIIB element selected from the group consisting of cerium, lanthanum, neodymium and yttrium.

6. A combined particulate filter and hydrocarbon trap according to claim 1, wherein the hydrocarbon adsorbent comprises ruthenium, iridium or both ruthenium and iridium.

7. A combined particulate filter and hydrocarbon trap according to claim 1, wherein the hydrocarbon adsorbent comprises an oxygen storage component.

8. A combined particulate filter and hydrocarbon trap according to claim 1, wherein the washcoat loading on the particulate filter is greater than 0.25 g/in³.

9. A combined particulate filter and hydrocarbon trap according to claim 1, wherein either one or both of the inlet and outlet surfaces include a plurality of washcoat layers and wherein each washcoat layer within the plurality of layers is the same as or different from the or each other washcoat layer in the plurality of layers.

10. A combined particulate filter and hydrocarbon trap according to claim 1, wherein the washcoat on the inlet surfaces has a mean pore size that is the same as or different from that on the outlet surfaces.

11. A combined particulate filter and hydrocarbon trap according to claim 1, wherein the washcoat is a surface washcoat.

12. A combined particulate filter and hydrocarbon trap according to claim 1, wherein the washcoat is coated on inlet and outlet surfaces and also within the porous structure of the porous substrate.

13. A combined particulate filter and hydrocarbon trap according to claim 1, wherein the washcoat sits substantially within the porous structure.

14. An exhaust system for a vehicular engine comprising a combined particulate filter and hydrocarbon trap according to claim 1.

15. An exhaust system according to claim 14, comprising a three-way catalyst disposed upstream and/or a three-way catalyst or an oxidation catalyst disposed downstream of the combined particulate filter and hydrocarbon trap.

16. An exhaust system according to claim 15, wherein the three-way catalyst is disposed downstream of the combined particulate filter and hydrocarbon trap.

17. An exhaust system according to claim 15, wherein the particulate filter and hydrocarbon trap is disposed directly in-line with the three-way catalyst.

18. An exhaust system according to claim 15, wherein the particulate filter and hydrocarbon trap is disposed in a by-pass system separate from the three-way catalyst.

19. An exhaust system according to claim 18, further comprising at least one change ober valve to control passage of exhaust gas.

20. An exhaust system according to claim 18, comprising at least one valve and control means for controlling the at least one valve, which control means being programmed, when in use, such that:
a) at engine cold start the exhaust gas flows only through the combined particulate filter and hydrocarbon trap;
b) the exhaust gas by-passes the combined particulate filter and hydrocarbon trap once the exhaust gas reaches a temperature just below the hydrocarbon desorption temperature of the hydrocarbon trap;
c) the exhaust gas flows through the combined particulate filter and hydrocarbon trap once the three way catalyst reaches its activation temperature;
d) the exhaust gas by-passes the combined particulate filter and hydrocarbon trap for a second time once the temperature of the exhaust gas is high enough to desorb any trapped hydrocarbons and burn off any particulate matter.

21. A vehicular internal combustion engine comprising an exhaust system according to claim 14.

22. A vehicular internal combustion engine according to claim 21, wherein the internal combustion engine is a gasoline direct injection engine.

23. A vehicle comprising an internal combustion engine according to claim 21.
